(19) United States
(12) Patent Application Publication
(10) Pub. No.: US 2022/0396390 A1
(43) Pub. Date: Dec. 15, 2022

(54) PORTABLE BOX

(71) Applicant: Yucel Huther Bekar, Çankaya/Ankara (TR)

(72) Inventors: Yucel HUTHER BEKAR, Çankaya/Ankara (TR); Gulay BEKAR, Çankaya/Ankara (TR)

(73) Assignee: Yucel Huther Bekar, Çankaya/Ankara (TR)

(21) Appl. No.: 17/775,869

(22) PCT Filed: Nov. 12, 2019
(86) PCT No.: PCT/TR2019/050942

§ 371 Date: May 10, 2022

(51) Int. Cl. B65D 5/46; A47J 47/14; B65D 85/36

(52) U.S. Cl. CPC B65D 5/46016; A47J 47/145; B65D 85/36; B65D 2585/366

(57) ABSTRACT

The invention relates to a portable food box which ensures boxes to be carried without requiring an additional plastic bag. In particular, the invention relates to a portable box comprising a carrying bag having a foldable form on a side of the box.

### TECHNICAL FIELD OF INVENTION

The invention relates to a portable food box which enables boxes to be carried without requiring an additional plastic bag.

In particular, the invention relates to a portable box comprising a carrying bag having a foldable form on a surface of the box.

State of Art:

Nourishment is undoubtedly one of our essential requirements nowadays. In general, people can prepare their own food, however sometimes they provide their nutritional requirements from the places selling food. In this regard, particularly the consumption of foods that are defined as fast food becomes widespread day by day. Since such foods become popular, they are consumed not only in places selling such foods but also in homes thanks to delivery services. Along with the advancing technology, home delivery services are employed more frequently and delivery methods are developed accordingly.

In general, food carrying boxes are used for carrying food. Those boxes both ensure food to be protected against factors such as dust, humidity and ensure food to be carried without heat loss. Those carrying boxes are generally in a square form for the sake of ease of carrying. Thus, the space took by the boxes at multi-carrying processes is more practical. Those square-formed boxes are used for carrying foods such as pizza, Turkish pizza and pita which should be carried horizontally.

Many box embodiments have been developed so as to be used in carrying, packing and storing those boxes.

The patent document no. “2017/04623” was examined as a result of the preliminary research conducted in the state of art. The following information is stated in the abstract section of the invention that is subject of the application: “this invention relates to a practical carrying bag that allows boxes of packaged products such as baklava, cookies, patties, cakes, pizza etc. for being packed and carried in many business, especially patisserie. The invention is comprised of a practical carrying bag, body, a strip part, a handle and an adhesive surface (band)”.

The patent document no. “2009/08374” was examined as a result of the preliminary research conducted in the state of art. In the abstract section of the invention subject to the application, the following information is stated: “the present invention generally relates to a food storage box made from a uniform plate material and more specifically a pizza box formed using a ready-to-fold corrugated cardboard for storing, carrying and serving hot pizza.”

The patent document no. “US20160345783” was examined as a result of the preliminary research conducted in the state of art. The invention subject to the application relates to a bag which is especially used for carrying pizza. The triangular bag is suitable for carrying multiple boxes. It is aimed to keep square boxes on a horizontal plane firmly while carrying food boxes by placing them in the inventive bag.

The patent document no. “DE29812168” was examined as a result of the preliminary research conducted in the state of art. The present invention relates to a pizza box carrying bag designed for carrying pizza boxes horizontally. This inventive bag has holes at two corners. Food boxes are placed in the bag in a manner that their corners correspond to the holes of the bag. It is aimed to keep square boxes on a horizontal plane firmly while carrying food boxes by placing them in the inventive bag.

The patent document no. “U.S. Pat. No. 5,524,949” was examined as a result of the preliminary research conducted in the state of art. The invention subject to the application relates to a carrying bag developed for carrying boxes having a square geometry. This inventive bag has a base to support the load base of the box to be carried. Furthermore, the lower corners of the bag have holes in order to keep the box at a horizontal position. The inventive bag has holes which are dimensioned and positioned to accept the protrusions of the box.

It is difficult to carry the carrying boxes which are used in the prior art by one hand. Bags that are developed for this purpose are available. However, those bags are simple systems which are formed by making holes on normal bags.

Triangular bags/pouches, which were developed for carrying square food boxes, are available in the prior art. Those bags are available except for the boxes and especially used to carry multiple boxes. Boxes are placed in those triangular boxes however they may slip down from pouch and fall.

Consequently, an improvement has been necessary in the technical field due to the problems mentioned above and insufficiency of the present solutions about the matter.

### OBJECTS OF THE INVENTION

The primary object of the invention is that it comprises a carrying bag that is fixed to a surface of food boxes, has a foldable feature and produced from preferably a kraft-like paper. Thus, the box is carried by the handle after opening the carrying box when one-hand carrying is desired.

Another object of the invention is that an additional support is provided to the base of the box by fixing the foldable carrying bag to the lower surface of the box.

Another object of the invention is that the carrying bag is fixed to the box, therefore problems such as slipping of the box from the bag are avoided.

Another object of the invention is that the boxes may be superimposed and packed or they may be carried by hand when desired as they comprise foldable carrying bags.

Another object of the invention is that it does not burn hands of the carrier as it enables to carry goods in a carrying bag.

Another object of the invention is that the foldable bag may be closed again after carrying and hence it does not occupy much space.

Another object of the invention is that storage area is improved as the foldable bag does not occupy much space in boxes in closed position. Therefore, a separate storage area is not necessary for the bag and the box.

Another object of the invention is that the carrying bag may be torn from the adhesion point and may be reused. Therefore, carrying bag may be reused based on the number of the adhesion point.

Another object of the invention is that the carrying bag may be applied on big packs. Therefore, carrying bags may be adhered to the side portions of relatively big boxes such as electronic device boxes and reused.

Another object of the invention is that it may be applied both on cardboard boxes and on tin cans.

Another object of the invention is that the foldable bag may be produced from materials except for kraft-like paper.

Another object of the invention is that it enables placing and carrying various materials in the space formed by making the carrying bag triangular after opening the foldable carrying bag.

The structural and characteristic features and all advantages of the invention shall be more clearly understood by the following drawings and detailed description stated by referring to these figures. Therefore, the evaluation must be carried out considering these drawings and the detailed description.

### DESCRIPTION OF DRAWINGS

FIG. 1; shows a top view of the opened state of the inventive portable food box.

FIG. 2; shows a bottom view of the opened state of the inventive portable food box.

FIG. 3; shows a detail view of the bottom surface of the inventive portable food box.

FIG. 4; shows a top perspective view of the closed state of the foldable bag of the inventive portable food box.

FIG. 5; shows a detailed bottom view of the foldable bag of the inventive portable food box.

FIG. 6; shows a detail view of the closing steps of the carrying bag of the inventive portable food box.

FIG. 7; shows a view of foldable bag of the inventive portable food box in an opened position.

FIG. 8; shows a bottom view of foldable bag of the inventive portable food box in an opened position

FIG. 9; shows a perspective view of the suitable-to-carry position of the foldable bag of the inventive portable food box.

FIG. 10; shows a view of the opened position of a suitable-to-carry pocket of the foldable bag of the inventive portable food box.

FIG. 11; shows a view that illustrates the carrying of the multiple boxes suitable to be carried by foldable bag of the inventive portable food box.

FIG. 12; shows a side view of the suitable-to-carry position of the foldable bag of the inventive portable food box.

FIG. 13; shows a bottom view of the suitable-to-carry position of the foldable bag of the inventive portable food box.

FIG. 14; shows a view illustrating the steps of foldable bag of the inventive portable food box in multiple uses.

FIG. 15; shows a top view of a surface of foldable bag of the inventive portable food box.

FIG. 16; shows a view of the method for applying foldable bag of the inventive portable food box to existing boxes.

### REFERENCE NUMERALS

100. Portable Box
110. Box Top Surface
120. Box Bottom Surface
121. Carrying Bag
122. Bag Handle
123. Folding Line
124. Fastening Point
125. Fixing Section
126. Bag Pocket
127. Perforation Point
128. Protective Band

### DESCRIPTION OF THE INVENTION

The inventive portable box (100) is in a form which allows the boxes for being stacked in a superimposed manner and carrying the same boxes using a carrying bag (121) by one hand if desired. Particularly the carrying bag (121) may be opened and carried by holding by the bag handle (122) when it is desired to be carried by one hand.

The inventive portable box (100) comprises a box top surface (110) at the upper side and a box bottom surface (120) at the lower side in general terms.

Box top surface (110) is used as a cover, therefore it enables to place food in and out of the portable box (100).

Box bottom surface (120) is the base of the portable box (100) and the part where the food in the portable box (100) is located. The box bottom surface (120) of the portable box (100) contains a carrying bag (121) at the outer surface. Carrying bag (121) is fixed to the box bottom surface (120) of the portable box (100) and is foldable. The carrying bag (121) is preferably made of a kraft-like paper. However, it can be made from plastic bag, fabric, canvas biodegradable packages.

The carrying bag (121) contains a carrying handle (122) which enables user to carry the box by hand, folding lines (123) assisting the carrying bag (121) to open and close, a fastening point (124) which prevents the carrying bag (121) to open from the closed position automatically after being folded, a fixing section (125) which ensures to fix the carrying bag (121) to the box bottom surface (120) and a bag pocket (126) which enables multiple products to be placed into the carrying bag (121).

Furthermore, folding lines (123) on the carrying bag (121) ensures carrying bag (121) to be closed and folded and placed on the box bottom surface (120) and to open the carrying bag (121) again for carrying goods.

The carrying bag (121) has a fastening point (124) containing an adhesive surface which prevents it to be opened automatically after being folded. Therefore, the portable box (100) may stand firm without being so thick when they are stacked up or when they are desired to be in closed position and the user can easily open the carrying bag (121) when he desires. Furthermore, fastening points (124) on the carrying handles (122) on the carrying bag (121) ensure the carrying handles (122) to be held together during carrying the portable box (100) as shown in FIG. 9. Therefore, the carrying bag (121) does not fall automatically.

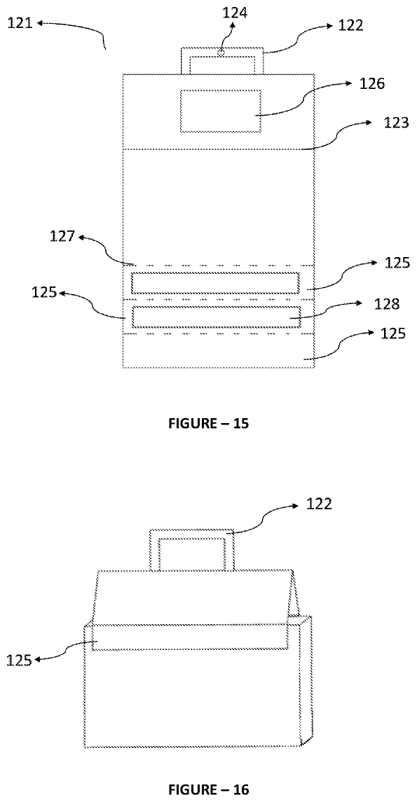

The fixing section (125) connects the carrying bag (121) to the portable box (100). The fixing section (125) contains a powerful adhesive. Therefore, problems such as release or slipping are avoided during carrying. Multiple fixing sections (125) are available on the carrying bag (121) as shown in FIG. 15. Therefore, the fixing section may be torn by the perforation point (127) on the fixing section (125) and the other fixing sections (125) may be applied to the available boxes after the portable box (100) is used. Steps of the repetitive use of fixing section (125) and portable box (121) are shown in FIG. 14. Thus, the carrying bag (121) with more than one fixing section (125) may be used repetitively as long as the available box sizes permit. A protective band (128) is available on each fixing section (125). Thus, the unused fixed section (125) is prevented to be adhered to the portable box (100).

Bag pocket (126) is placed on the portable box (121) and ensures additional goods to be carried. Particularly, food in addition to food in a portable box (100) may be carried in the bag pocket (126) when food-like products are carried.

Additional goods may be placed in the bag pocket (126) and carried as shown in FIG. 10. For example, when a user buys a pizza, he can place goods such as drinks, ketchup, mayonnaise, sauce, fork or knife in the bag pocket (126) while he carries the pizza in the portable box (100). Therefore, extra use of bags is avoided.

Fixing the foldable carrying bag (121) on the box bottom surface (120) ensures an additional support to the portable food box (100) during carrying. Therefore, deformation of portable food box (100) by food is avoided. Furthermore, the carrying bag (121) may ensures the user's hand not to be affected by heat.

Problems such as slipping and dislocation are avoided while carrying the carrying bag (121) as the carrying bag (121) is fixed to the bottom surface (120) of the portable box (100). Furthermore, a gap is formed while carrying the portable box (100) with the carrying bag (121) as shown in FIG. 12. Various goods can be placed and carried in this gap.

The carrying bag (121) may be fixed to the box bottom surface (120) by an adhesive through ultrasonic method or heating method or during compression.

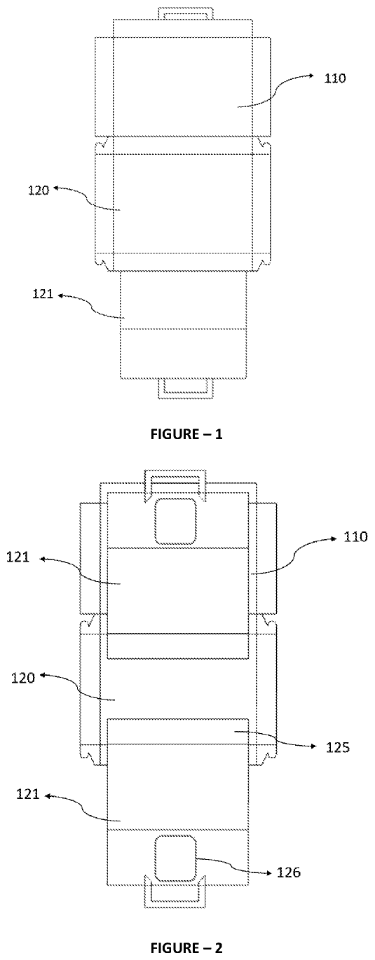

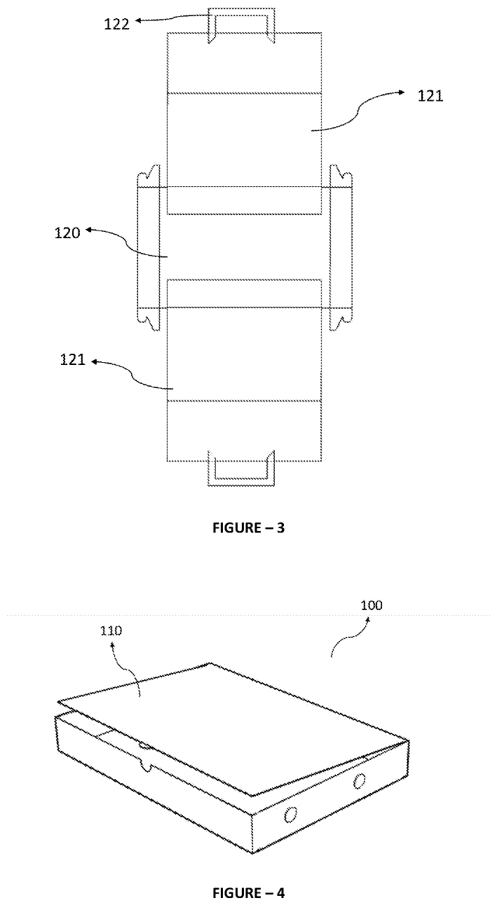

Opened view of the inventive portable box (100) is shown in FIG. 1 and FIG. 2. FIG. 1 shows the inner surface of the portable box (100), that is to say, the section including food. A part of the carrying bag (121) is shown and the other part is not shown as it is under the box top surface (110). FIG. 2 shows the outer surface of the portable box (100). FIG. 2 shows the carrying bag (121) in an opened view. The carrying bag (121) is fixed to the box bottom surface (120) as shown in FIG. 2 and FIG. 3.

The portable box (100) is closed by the edge surfaces and by means of locking latches and takes the box form as shown in FIG. 4. This form may be in square, polygonal, round, triangular or in any geometrical shapes.

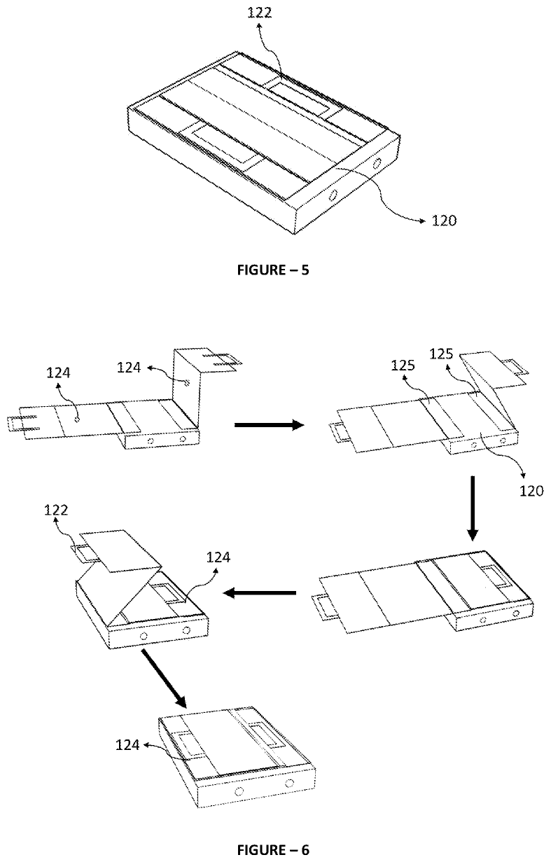

The carrying bag (121) is folded by the folding lines (123) and takes the position in FIG. 5. The carrying bag (121) is joined to each other at the fastening point (124) in a manner to prevent it from opening in this position and enable to easily open when desired. This fastening operation is conducted by a soft adhesive. Therefore, the carrying bag (121) is not opened automatically or by an external force when closed. Portable boxes (100) may be stacked up in a superimposed position when the carrying bag (121) is closed.

Thus, portable boxes (100) may be stored in a superimposed manner as in a ready-to-serve position. The carrying bag (121) does not cause an additional thickness for the portable box (100) when it is in closed position. Thus, an easy stacking up is ensured.

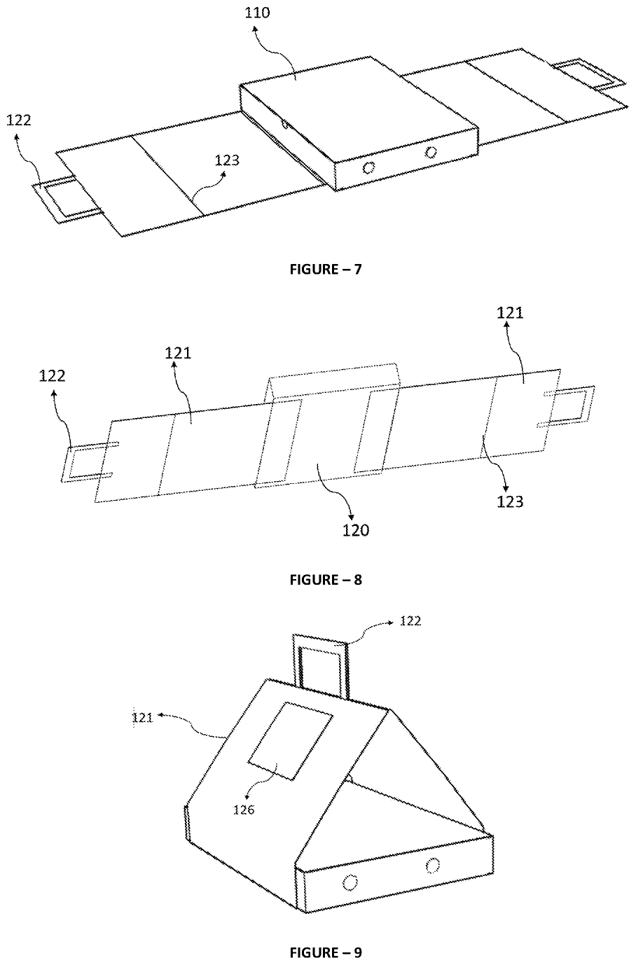

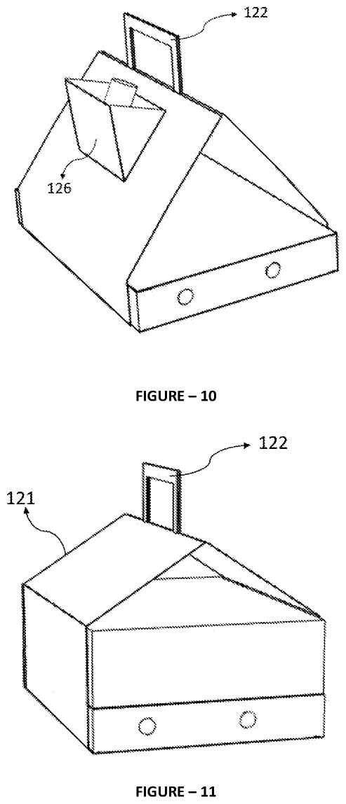

A section of the carrying bag (121) stands as fixed to bottom surface (120) of the box when it is opened by a user as shown in FIG. 7 and FIG. 8. User holds by the carrying handle (122) and takes its position as shown in FIG. 9 through force of gravity. Thus, the portable box (100) can be carried easily by the carrying bag (121).

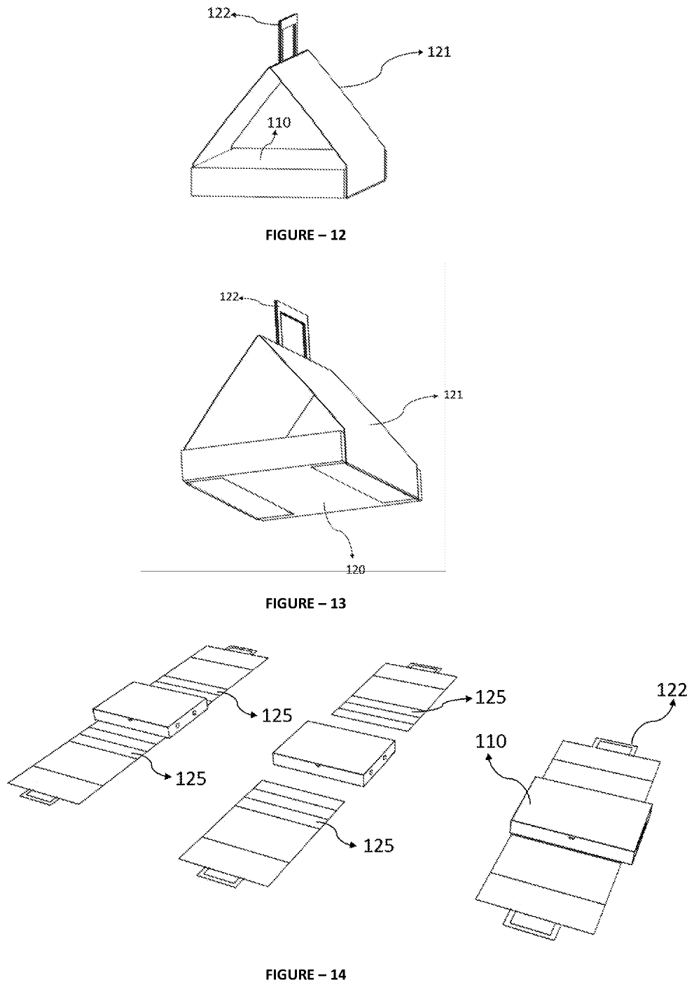

The carrying bag (121) ensures an additional support to the box bottom surface (120) when it is opened by a user as shown in FIG. 13. Thus, the weight is distributed throughout the surface of portable box (100) and the load is not applied to carrying handle (122).

Although the carrying bag (121) of the inventive portable box (100) is fixed to the box bottom surface (120), it can also be fixed to side surfaces or top surface (110) of the box or any point of the portable box (100) optionally.

Carrying bag (121) is in a form which can be applied to the present boxes in the prior art. Thus, the present boxes are provided to be the inventive portable box (100) by being fixed to the present boxes by means of adhesion and ultrasonic method.

The carrying bag (121) can be used repetitively as much as the number of the fixing sections (125) as the carrying bag (121) can be torn from the relevant point of the multiple fixing section (125). The number is more than one and can be used as much as desired.

The carrying bag (121) of the inventive portable box (100) can be applied to present big packs as shown in FIG. 14. Therefore, the carrying bag (121) can be used by being adhered to the side sections of relatively bigger boxes such as electronic device boxes by the fixing section (125).

The carrying bag (121) of the inventive portable box (100) ensure carrying action for not only cardboard boxes but also for tin boxes. Particularly tins such as oil, paste tins which are heavy to carry are carried using a carrying bag (121) by adhering the fixing section (125) to their side sections.

1. A portable box (100) for carrying products, characterized in that it comprises;
a box top surface (110) that is used as a cover and ensures food to be placed in and out of the portable box (100),
a box bottom surface (120) which is the base of portable box (100) where food placed in the portable box (100) is located; comprises a carrying handle (122) enabling the portable box (100) to be carried by the user; a fastening point (124) having an adhesive surface preventing the carrying bag (121) from switching to an opened position from a closed position automatically after folding; at least a fixing section (125) that provides a connection to the box bottom surface (120) or side surface of the box, that has an adhesive surface and that can be torn from the perforation point (127); a foldable carrying bag (121) with a bag pocket (126) enabling user to place extra product thereon.

2. A portable box (100) according to claim 1, wherein it comprises folding lines (123) which ensures the carrying bag (121) to be positioned to the box bottom surface (120) by folding and the carrying bag (121) to be opened again for carrying goods.

3. A portable box (100) according to claim 1, wherein it comprises multiple perforation points (127) on the carrying bag (121) which ensure to tear the fixing section (125) in order to apply the carrying bag to the present boxes after the portable box (100) is used.

4. A portable box (100) according to claim 1, wherein each fixing section (125) comprises a protective band (128), which prevents the non-fixed fixing section (125) from adhering to the portable box (100) thereon.

5. A portable box (100) according to claim 1 wherein it comprises a fastening point (124) preventing the carrying bag (121) to form an extra thickness while stacking up the portable box (100) and providing the carrying bag (121) to remain fixed in closed state and providing the user to open carrying bag (121) when he desires.

6. A portable box (100) according to claim 1, wherein it comprises a carrying bag (121) preventing goods from deforming the portable box (100) while being carried by fixing the same to the box bottom surface (120) and ensuring additional support to the base of the portable box (100) while carrying the same, and fixed to the bottom surface of the box (120), thereby preventing the portable box (100) to slide and become unattached while carrying.

7. A portable box (100) according to claim 1, wherein it comprises a carrying handle (122) ensuring the user's hand to be protected against heat of hot products to be placed into the portable box (100).

8. (canceled)

9. A portable box (100) according to claim 1, wherein the carrying bag (121) is made of a kraft-like pepper, cardboard, plastic bag, fabric, cloth, and biodegradable package.

10. A portable box (100) according to claim 1, wherein the portable box (100) comprises gap that ensures various goods to be carried due to its geometrical shape during its being carried by the carrying bag (121).

11. A portable box (100) according to claim 1, wherein it is in a form ensuring portable boxes (100) to be stacked up optionally in a superimposed manner and carrying bags to be carried optionally in a carrying bag (121) at one hand.

12. A portable box (100) according to claim 1, wherein the carrying bag (121) can be fixed to box bottom surface (120) using an adhesive or by ultrasonic method.

13. (canceled)

14. A portable box (100) according to claim 1, wherein the portable box (100) may be produced in a square, polygonal, rectangular, circular, and triangle form.

15.-19. (canceled)

20. A portable box (100) according to claim 1, wherein it comprises a carrying bags (121) which are fastened to each other in a manner to be protected against being opened automatically or without applying an outer force and to be opened easily whenever desired.

21. A portable box (100) according to claim 1, wherein it comprises optionally a carrying bag (121) which can be fixed to side surfaces of an optional portable box (100) or on the top surface (110) of the box.

22. A portable box (100) according to claim 1, wherein it comprises a carrying bag (121) which ensures box, cardboard and tin to be carried by the fixing section (125) thereon.

23. A portable box (100) according to claim 3, wherein each fixing section (125) comprises a protective band (128), which prevents the non-fixed fixing section (125) from adhering to the portable box (100) thereon.
